(19) United States
(12) Patent Application Publication
(10) Pub. No.: US 2018/0169532 A1
(43) Pub. Date: Jun. 21, 2018

(54) GAMING CONTROLLER CASE AND STAND COMBINATION

(71) Applicant: KANEX, Brea, CA (US)

(72) Inventor: Kelvin Yan, Brea, CA (US)

(21) Appl. No.: 15/850,172

(22) Filed: Dec. 21, 2017

Related U.S. Application Data
(60) Provisional application No. 62/437,215, filed on Dec. 21, 2016.

(51) Int. Cl. A63F 13/98

(52) U.S. Cl. CPC A63F 13/98

(57) ABSTRACT

The present invention is generally a protective case for a gaming controller, which is design with at least one casing configured to support a portion of a gaming display device. The case may therefore serve to protect a gaming controller when it is not in use, as well as a stand for a display device to be used in combination with the gaming controller during a gaming experience. In exemplary embodiments, the gaming controller case can be constructed with a first casing including a cavity configured to receive a gaming controller, and a second casing including a surface configured to support a gaming display that is separate from the gaming controller.

### PRIORITY NOTICE

The present application claims priority under 35 U.S.C. § 119(e) to U.S. Provisional Patent Application with Ser. No. 62/437,215, filed on Dec. 21, 2016, the disclosure of which is incorporated herein by reference in its entirety.

### TECHNICAL FIELD OF THE INVENTION

The present invention relates in general to a gaming controller protective case and stand combination, and more specifically to a protective case for a gaming controller, which is designed with at least one casing configured to support a portion of a gaming display device. The case may therefore serve to protect a gaming controller when it is not in use, as well as a stand for a display device to be used in combination with the gaming controller during a gaming experience.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

As technological advances reach new heights, the video game industry has seen a continued rise in mobile gaming device products. While even twenty years ago mobile gaming was widely available, the increasing number of users on mobile devices—such as smartphones and tables—has increased a demand and thus a supply of mobile device gaming hardware and software. That is, the available market share for mobile game developers continues to grow as virtually everyone in the more developed countries owns or has access to a mobile device. Moreover, as technological advances within the industry bring improved video processing power, the quality of mobile games has also seen considerable improvement. In fact, there is a current trend for making games that were traditionally only available via a local personal computer or gaming console, accessible either via cloud computing or on the increasingly more powerful mobile gaming devices such as smartphones and tablets.

Accordingly, it is now common for video game enthusiasts to have travel kits or transportable gaming hardware that they may take with them on travel. Moreover, while gaming is certainly available strictly via a mobile device such as a smartphone or table, certain games are better experienced when played with a suitable controller. As such, in today's developing gaming environment, it is desirable for gamers to travel with a gaming controller suitable for pairing with mobile devices.

One consideration for transporting a gaming controller safely from one place to another is keeping the controller from unnecessary impacts or unintended pressure on the controller keys. Other considerations of course include keeping the controller from excessive dust, or from coming into contact with undesired particles that may damage the controller. To these ends, carrying cases and pouches are typically employed to keep the gaming controller packed away. When a user is traveling and desires to play a game on a mobile device, the controller may be taken out and paired with the mobile device.

A widespread problem faced by users of prior art designs is that when the mobile device including a gaming display is to be used, the mobile device or gaming display is normally placed on a separate stand, rested against a book, or some other structure; this arrangement is typically unsatisfying and undesirable to a gamer.

The prior art has provided several solutions, but these are inadequate. For example, some pouches with integrated stands require your mobile device, gaming display, and gaming controller to comprise a single unit. This is undesirable, as typically, gamers that travel with their gaming controller do not want to use a controller interface provided by other devices. Other prior art gaming systems offer protective cases for their mobile device that include a controller interface that is integral with the protective case. This variation of course has the same drawback of preventing a gamer from using their own controller.

Therefore, there are several problems with the current state of the art, which have not been adequately addressed. The problems persist because a need to provide a gaming controller protective case and stand combination has not been adequately met. Accordingly, there is an unanticipated or inadequately addressed need for a gaming controller protective case and stand combination. Particularly, a protective case and stand combination that offers protection to a gamer's controller while the controller is not in use, and additionally provides a stand support means for a gaming display when the gaming controller can be implemented into a gaming experience.

It is to these ends that the present invention has been developed.

### SUMMARY OF THE INVENTION

To minimize the limitations in the prior art, and to minimize other limitations that will be apparent upon reading and understanding the present specification, the present invention describes a protective case for a gaming controller, which is design with at least one casing configured to register with a portion of a gaming display device. The case may therefore serve to protect a gaming controller when it is not in use, as well as a stand for a display device to be used in combination with the gaming controller during a gaming experience.

Generally, the present invention involves a protective cover or case for concealing or otherwise securing therein a gaming controller. A shell or casing of the protective case includes a surface that is configured to receive a portion of a display device in a manner such that the protective case functions as a stand for the display device. With such protective case, a gamer may transport their favorite gaming controller and use the protective case as a stand for the gaming display when the controller is in use.

A gaming controller case, in accordance with an exemplary embodiment of the present invention, comprises: a first casing including a cavity configured to receive a gaming controller; and a second casing including a surface configured to support a gaming display that is separate from the gaming controller.

A gaming controller case, in accordance with another exemplary embodiment of the present invention, comprises: a first casing including a cavity adapted to receive a portion of a gaming controller that is separate and distinct from a gaming display; and a second casing removably coupled to the first casing and having an outer surface comprising an elongated channel defined between a ridge situated along a length of the outer surface and a lip protruding above a channel surface within the channel between a retaining wall of the lip and a retaining wall of the ridge, the elongated channel adapted to receive a portion of the gaming display.

A gaming controller case, in accordance with yet another exemplary embodiment of the present invention, comprises: a first casing including a cavity adapted to receive a portion of a gaming controller that is separate and distinct from a gaming display; and a second casing swivably coupled to the first casing and having an outer surface comprising a channel defined between a first retention member and a second retention member situated along a length of the outer surface, the channel adapted to receive a portion of the gaming display.

A gaming kit, in accordance with an exemplary embodiment of the present invention, comprises: a gaming controller that is separate and distinct from a gaming display, the gaming controller including a directional pad and a user interface including one or more action buttons; and a protective case, comprising: a first casing including a cavity adapted to receive a portion of a gaming controller that is separate and distinct from a gaming display; and a second casing swivably coupled to the first casing and having an outer surface comprising an elongated channel defined between a ridge situated along a length of the outer surface and a lip protruding above a channel surface within the channel between a retaining wall of the lip and a retaining wall of the ridge, the elongated channel adapted to receive a portion of the gaming display.

It is an objective of the present invention to provide a means to protect a gaming controller when it is not in use.

It is another objective of the present invention to provide a gaming stand suitable to hold a gaming display.

It is yet another objective of the present invention to provide a protective case and gaming display stand in a single device so as to maximize portability.

It is yet another objective of the present invention to provide a case and gaming display stand combination that is inexpensive to construct, light-weight, yet sturdy enough to protect a gaming controller housed therein.

These and other advantages and features of the present invention are not set above as limiting objectives, but are described herein with specificity so as to make the present invention understandable to one of ordinary skill in the art.

### BRIEF DESCRIPTION OF DRAWINGS

Elements in the figures have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. The drawings that accompany the detailed description can be briefly described as follows:

FIG. 1(a) illustrates a perspective view of a system or kit including a gaming controller and gaming controller protective case in accordance with an exemplary embodiment of the present invention, shown in an open configuration.

FIG. 1(b) illustrates a perspective view of the gaming controller protective case illustrated in FIG. 1(a), depicted in a closed configuration.

FIG. 1(c) illustrates a perspective view of a gaming controller protective case in accordance with an exemplary embodiment of the present invention, wherein the protective cover is being used as a stand for a display device in a vertical orientation.

FIG. 1(d) illustrates a side view of the gaming controller protective case and display device depicted in FIG. 1(c).

FIG. 1(e) illustrates a perspective view of a gaming controller protective case in accordance with an exemplary embodiment of the present invention, wherein the protective cover is being used as a stand for a display device in a horizontal orientation.

FIG. 1(f) illustrates a cross-sectional side view of the gaming controller protective case and display device depicted in FIG. 1(c)-FIG. 1(d).

FIG. 1(g) illustrates a cross-sectional side view of an alternative embodiment of a gaming controller protective case, similar to the embodiment depicted in FIG. 1(f).

FIG. 1(h) illustrates a cross-sectional side view of an alternative embodiment of a gaming controller protective case, similar to the embodiment depicted in FIG. 1(f).

FIG. 2(a) illustrates a perspective view of a case in accordance with an exemplary embodiment of the present invention.

FIG. 2(b) illustrates a front view of a case in accordance with an exemplary embodiment of the present invention.

FIG. 2(c) illustrates a top view of a case in accordance with an exemplary embodiment of the present invention.

FIG. 2(d) illustrates a bottom view of a case in accordance with an exemplary embodiment of the present invention.

FIG. 2(e) illustrates a side view of a case in accordance with an exemplary embodiment of the present invention.

FIG. 2(f) illustrates another side view of a case in accordance with an exemplary embodiment of the present invention.

FIG. 2(g) illustrates a posterior view of a case in accordance with an exemplary embodiment of the present invention.

FIG. 3(a) illustrates a perspective view of an exemplary system or kit in accordance with one embodiment of the present invention.

FIG. 3(b) illustrates the kit shown in FIG. 3(a), the display device in an alternative orientation.

FIG. 4(a) illustrates a perspective view of an exemplary system or kit in accordance with another embodiment of the present invention, the case in an open configuration for maximizing support of a larger display device.

FIG. 4(b) illustrates another view of the system shown in FIG. 4(a).

### DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention. Wherever possible, the same reference numbers are used in the drawings and the following description to refer to the same or similar elements.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and or steps. Thus, such conditional language is not generally intended to imply that features, elements and or steps are in any way required for one or more embodiments, whether these features, elements and or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and or” means that “and” applies to some embodiments and “or” applies to some embodiments. Thus, A, B, and or C can be replaced with A, B, and C written in one sentence and A, B, or C written in another sentence. A, B, and or C means that some embodiments can include A and B, some embodiments can include A and C, some embodiments can include B and C, some embodiments can only include A, some embodiments can include only B, some embodiments can include only C, and some embodiments include A, B, and C. The term “and or” is used to avoid unnecessary redundancy.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

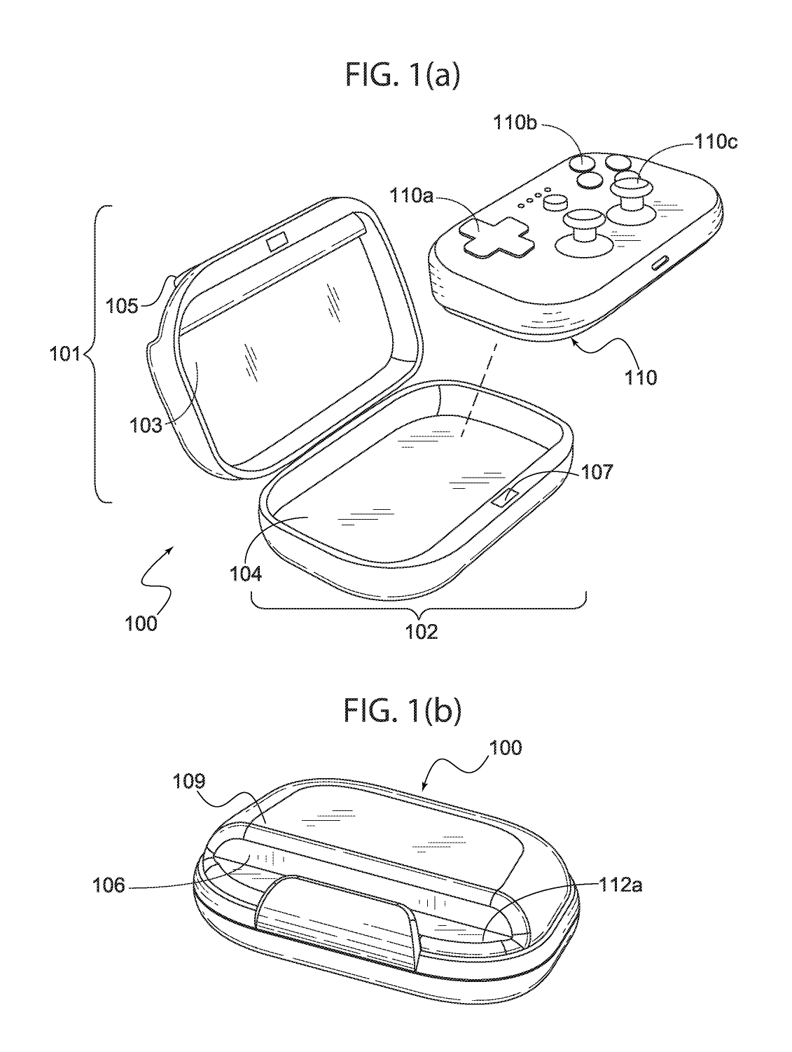

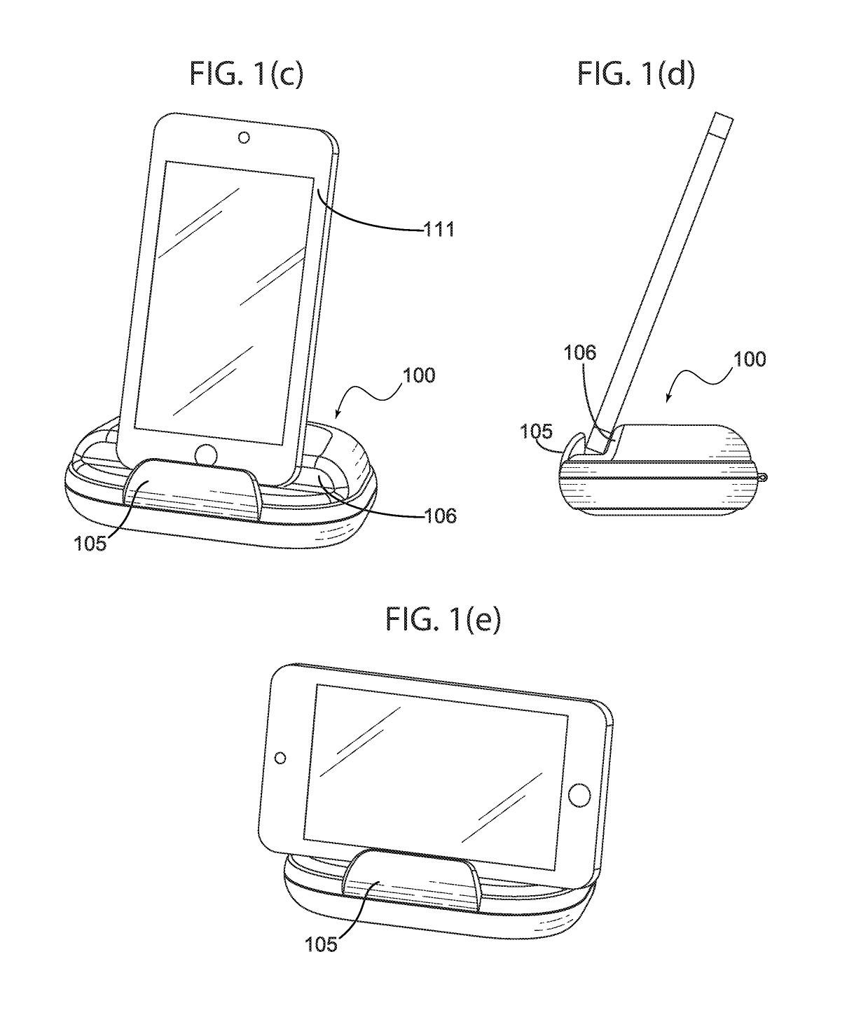

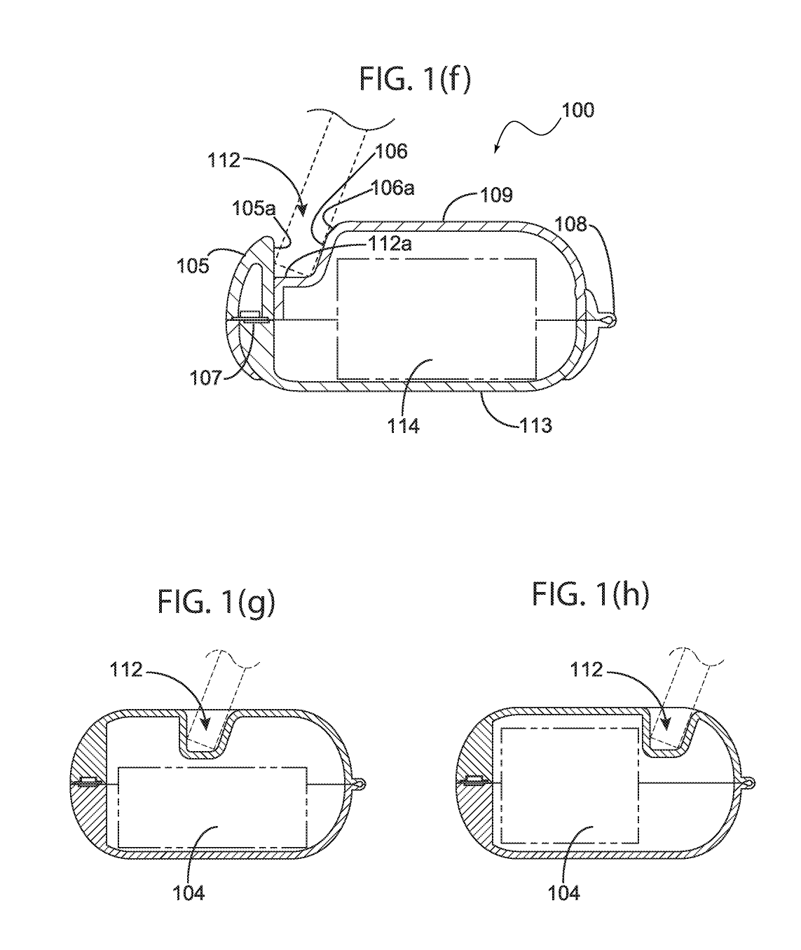

Turning now to the figures, FIG. 1(a) illustrates a perspective view of a system or kit including a gaming controller and gaming controller protective case in accordance with an exemplary embodiment of the present invention, shown in an open configuration; FIG. 1(b) illustrates a perspective view of the gaming controller protective case illustrated in FIG. 1(a), depicted in a closed configuration; FIG. 1(c) illustrates another perspective view, wherein the protective cover is being used as a stand for a display device in a vertical orientation; FIG. 1(d) illustrates a side view of the gaming controller protective case and display device depicted in FIG. 1(c); and FIG. 1(e) illustrates another perspective view wherein the protective cover is being used as a stand for a display device in a horizontal orientation. More specifically, FIG. 1(a)—FIG. 1(e) depict a system or kit, which includes a case 100 for concealing a gaming controller 110 within its protective shells—or casings 101 and 102—therein, case 100 configured to receive a portion of a gaming display device 111 (see FIG. 1(c)) on one of its casing surfaces.

A gaming display device or simply display device 111 in accordance with the present invention may include, without limitation, a mobile phone, a smartphone, a tablet or any other mobile device with a display and enough processing power to execute a video game capable of being played using a gaming controller such as gaming controller 110.

Gaming controller 110 may be any type of gaming controller suitable for controlling games that may be displayed on display device 111. As will be appreciated by those skilled in the art, gaming controller 110 may generally include a user interface that comprises one or more action buttons, pads, joysticks and the like to facilitate gaming. Accordingly, in the exemplary embodiment shown, gaming controller 110 includes directional pad 110a, one or more buttons 110b, and one or more joysticks 110c. Of course, other variations of actions buttons and or gaming interfaces may be implemented without deviating from the scope of the present invention.

Typically, a kit in accordance with the resent invention may include gaming controller 110 as well as a gaming controller protective cover, such as cover 100.

Cover 100 may include a first casing 101, which may be a top casing that includes a cavity or top cavity 103 for registering with or otherwise receiving a portion of gaming controller 110. A second casing 102 may be a bottom casing that includes another cavity or bottom cavity 104, wherein the top cavity of casing 101 and the bottom cavity 104 of second casing 102 form cavity 114 for registering with or otherwise receiving gaming controller 110 within.

Casing 101 typically includes a surface, such as a top surface or outer surface 109 having a first retaining member 105 opposite to and spaced apart from a second retaining member 106 that together form an elongated cavity or channel 112 on the outer surface 109 of casing 101 that is suitable for sliding, registering, or otherwise receiving therein a portion of display device 111. The specific construction and structural design of the retaining members on the top surface may vary without deviating from the scope of the present invention. For example, FIG. 1(b) and FIG. 1(c) disclose an exemplary embodiment wherein retaining member 105 comprises an anterior lip at the front of the top surface of casing 101, and retaining member 106 comprises a retaining wall formed by a sudden recess or ridge 106a at the top of the outer surface 109 of casing 101. In other embodiments, such as the one depicted in FIG. 1(h) one of the retaining members may be a posterior lip. And in yet another embodiment, such as the one depicted in FIG. 1(g) one of the retaining members may be an elongated anterior lip, wherein the channel cuts across a length and along the middle of the outer surface of casing 101.

At the top portion of the retaining wall or retaining member 106, ridge 106a may create a substantially perpendicular angle with the outer surface 109 or may be slightly slanted (as shown in several figures) to provide an angled support for display device 111. At the bottom portion of retaining member 106, a channel surface 112a may be substantially parallel with the outer surface 109 and substantially perpendicular to or angled with retaining member 106. Channel surface 112a generally runs the entire length of casing 101 and extends from retaining member 106 towards the anterior or front portion of protective case 101, the anterior lip typically situated at a middle portion of the outer-most edge of the outer surface 109 so as to form channel 112 at the front of casing 101 of protective cover 100. In exemplary embodiments, the channel surface 112a may be typically perpendicular or angled to retaining member 106 and extends until reaching retaining member 105. As will be discussed below, in other exemplary embodiments, retaining member 105 and retaining member 106 may be formed at a middle section of outer surface 109 to form an elongated cavity or channel 112 that runs through a middle section of outer surface 109 for sliding, registering, or otherwise receiving therein a portion of a display device. In yet other exemplary embodiments, as will be further discussed below, retaining member 105 and retaining member 106 may be formed at a posterior section of outer surface 109 to form an elongated cavity or channel 112 that runs through a posterior section of outer surface 109 for sliding, registering, or otherwise receiving therein a portion of a display device.

As may be appreciated from the various views discussed above, display device 110 may be set in a first configuration or vertically oriented and secured within channel 112 on top of channel surface 112a of case 100, as illustrated in FIG. 1(c), resting at a slight angle between retaining member 105 and retaining member 106. Alternatively, display device 110 may be set in a second configuration or horizontally oriented and secured within channel 112 on top of channel surface 112a of case 100, as illustrated in FIG. 1(e), resting at a slight angle between retaining member 105 and retaining member 106 (see also FIG. 1(f)).

FIG. 1(f) illustrates a cross-sectional side view of gaming controller protective case 100 and display device 110 as depicted in FIG. 1(e). More specifically, from this view retaining member 105 is depicted as an anterior lip or structure that rises upwards and includes a curvature on a front surface of retaining member 105 that arches towards a back portion of case 100 or towards hinge 108 and suddenly drops off with a retaining wall 105a that is approximately perpendicular with channel surface 112a of channel 112. Opposite to retaining wall 105a of retaining member 105 is a complementary retaining wall or retaining member 106, which crests at ridge 106a and may be slanted slightly as shown in order to provide a slanted support to display device 111. Below a bottom surface of retaining member 105 is typically a sealing means or locking mechanism that allows case 100 to securely close casing 101 and casing 102, such as a magnetic component 107. From this view, it may be appreciated that when in a closed configuration the top cavity 103 of casing 101 and the bottom cavity 104 of second casing 102 form cavity 114 for securely receiving gaming controller 110 within. Naturally, cavity 104 may be configured in any shape that contours or otherwise registers with a body or shape of gaming controller 110.

Turning to the next figures, FIG. 1(g) and FIG. 1(h) illustrate a cross-sectional side views of alternative embodiments of a gaming controller protective case, similar to the embodiment depicted in FIG. 1(a)-FIG. 1(f). More specifically, FIG. 1(g) depicts an embodiment in which channel 112 is situated along a length of cover 100 but rather than at an anterior or front portion of casing 101, channel 112 cuts along the middle of outer surface 109. In yet another exemplary embodiment, FIG. 1(h) depicts an embodiment in which channel 112 is situated along a length of cover 100 but rather than at an anterior or front portion of casing 101, channel 112 cuts along the posterior or back portion of outer surface 109.

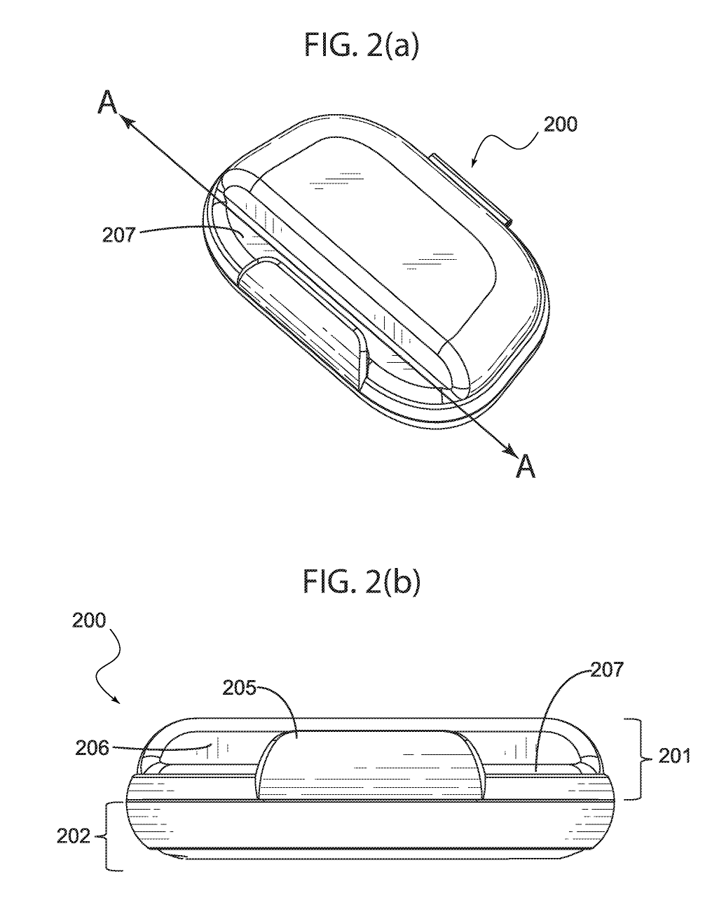

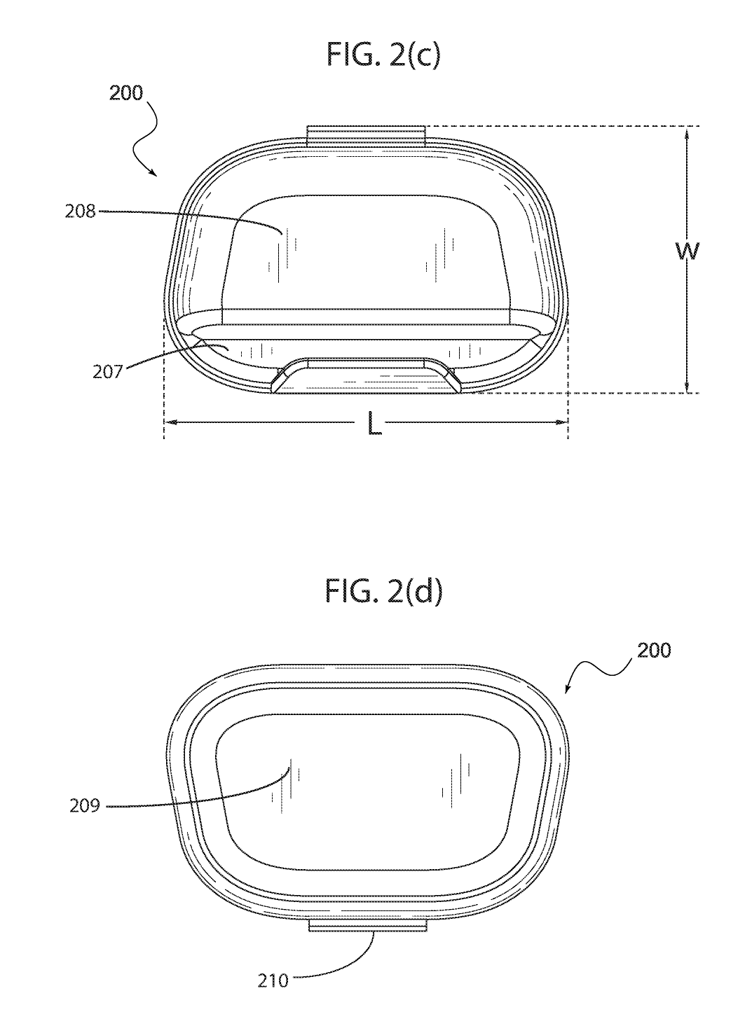

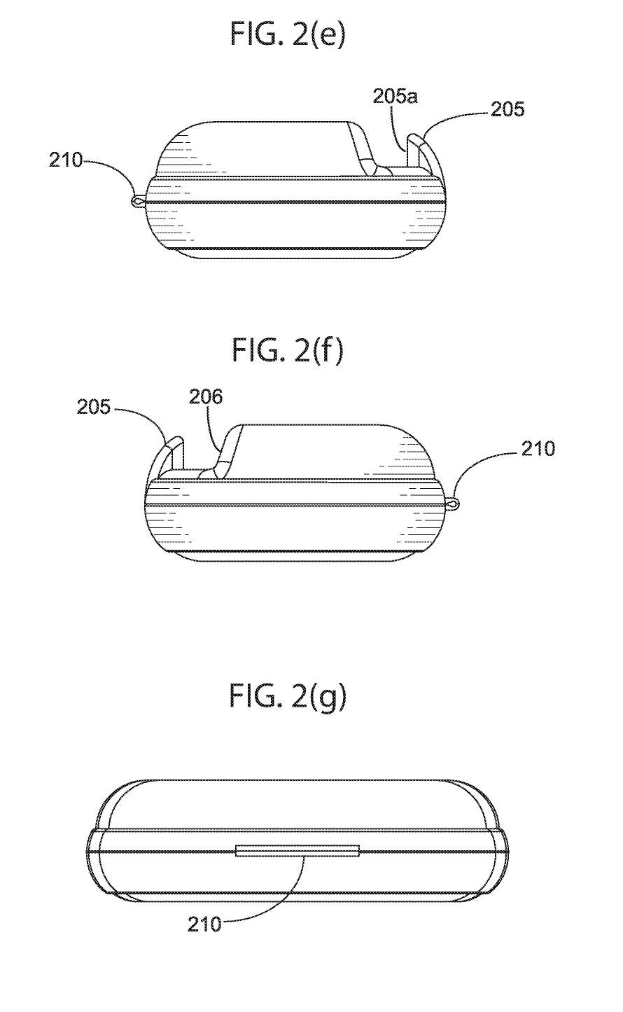

Turning now to the next set of figures, FIG. 2(a) illustrates a perspective view of a protective case in accordance with an exemplary embodiment of the present invention; FIG. 2(b) illustrates a front view thereof; FIG. 2(c) illustrates a top view thereof; FIG. 2(d) illustrates a bottom view thereof; FIG. 2(e)-2(f) illustrate side views thereof; and FIG. 2(g) illustrates a posterior view of the protective case.

More specifically, FIG. 2(a)-2(f) depict protective case 200, in accordance with an exemplary embodiment of the present invention, comprising a channel surface 207 for receiving a portion of a display within a channel A formed by support components 205 and 206 on a top casing 201 of protective case 200; these figures illustrate case 200 in a closed configuration thus casing 201 resting securely atop bottom casing 202, both casings configured to receive and conceal at least a portion of a gaming controller when closed. The various views, help disclose exemplary design features and structural characteristics of a protective case in accordance with the present invention.

As can be appreciated from FIG. 2(a), channel A runs across an anterior portion of top casing 201 between a protruding retention member or support component 205 and support component 206. Channel A typically, although not necessarily, extends longitudinally across an entire length of case 200. Of course, the dimensions of channel A may vary without deviating from, or limiting, the scope of the present invention; however, whatever the specific dimensions, channel A should be deep (or high) enough and long and wide enough to secure a portion of a display device between support components 205 and 206.

In FIG. 2(a), FIG. 2(c), and particularly in FIG. 2(e)-(f), an exemplary embodiment of support component 205 is shown having an anterior arching portion extending from the front of case 200, which partially arches towards the back of case 200 and more specifically towards a retaining wall formed by support component 206. A back surface 205a of support component 205 is substantially perpendicular to channel surface 207, however less than substantially parallel to the retaining wall formed by support component 206, which slants slightly. This configuration may be, for example, beneficial to slightly tilt a display device placed on channel surface 207 once the display device is registered with channel A of casing 201 of case 200. Naturally certain features of support component may vary without deviating from the scope of the present invention. For example, the anterior arching portion of support component 205 need not have a curvature and may be flat; the height may vary as indicated above; and the length and width of support component 205 may expand the entire front portion of casing 201 or be limited to a smaller width as shown. Support component 206 may also vary in height, length, etc., so long as channel A and each support component 205 and 206 adequately provide a supportive structure to stand a display device therein.

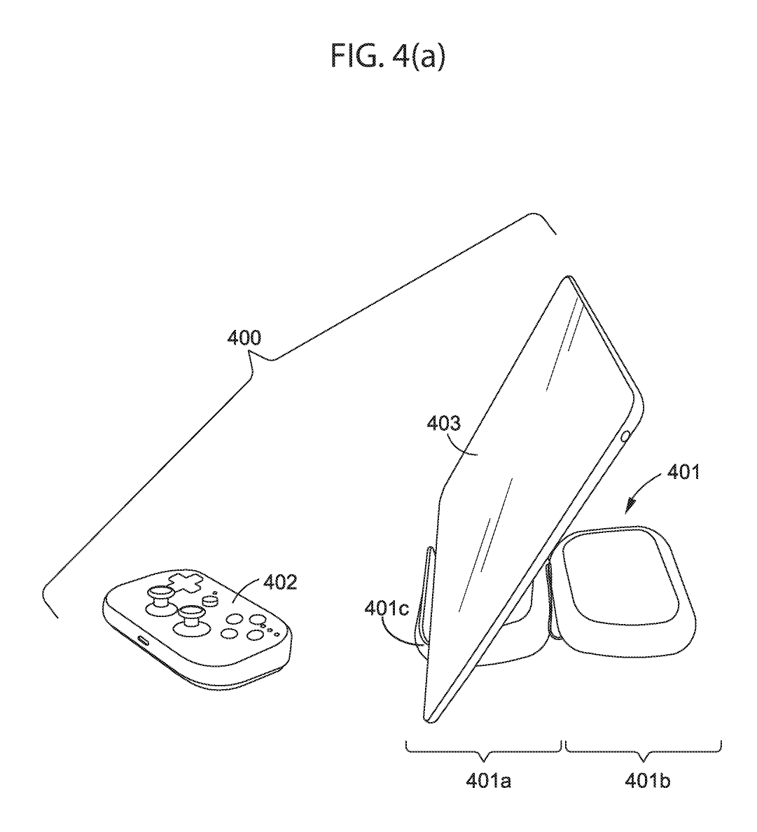

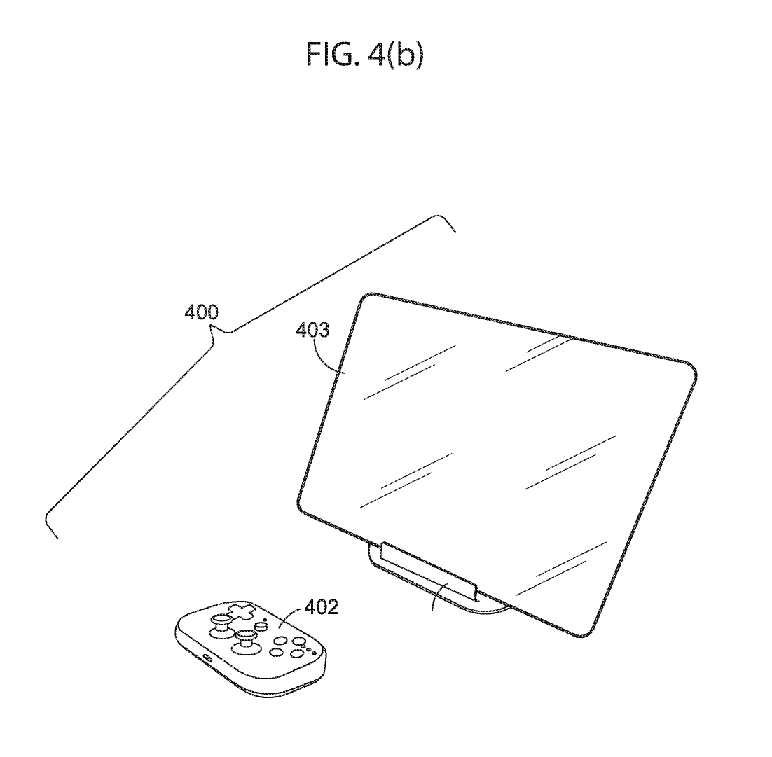

FIG. 2(c) also shows how in an exemplary embodiment, an outer or top surface 208 of casing 201, or portion thereof, is preferably flat. Similarly, FIG. 2(d) shows a bottom surface 209 of casing 202, a portion thereof which is flat as well. Moreover, FIG. 2(d) specifically refers to a hinged portion at the posterior or back of case 200, which enables casing 201 and casing 202 to lay completely flat when both casings 201 and 202 are swivably opened (see for example FIGS. 4(a)-4(d)); as will be discussed further below, such configuration adds support for larger display devices. The swiveling component or hinge 210 is further depicted in FIG. 2(e)-2(g), but is typically a structure that couples or connects both casings together in a manner that allows each casing to swivel or pivot between a closed and open configuration.

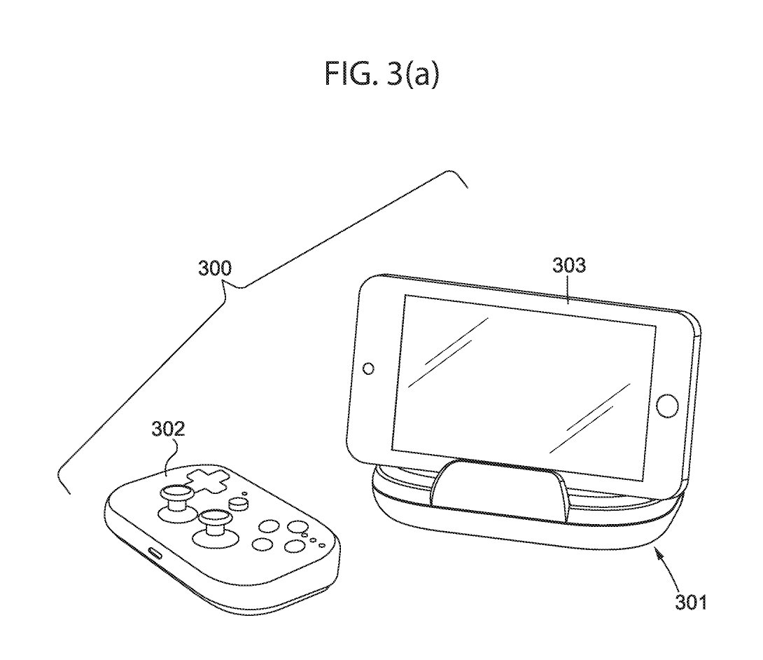

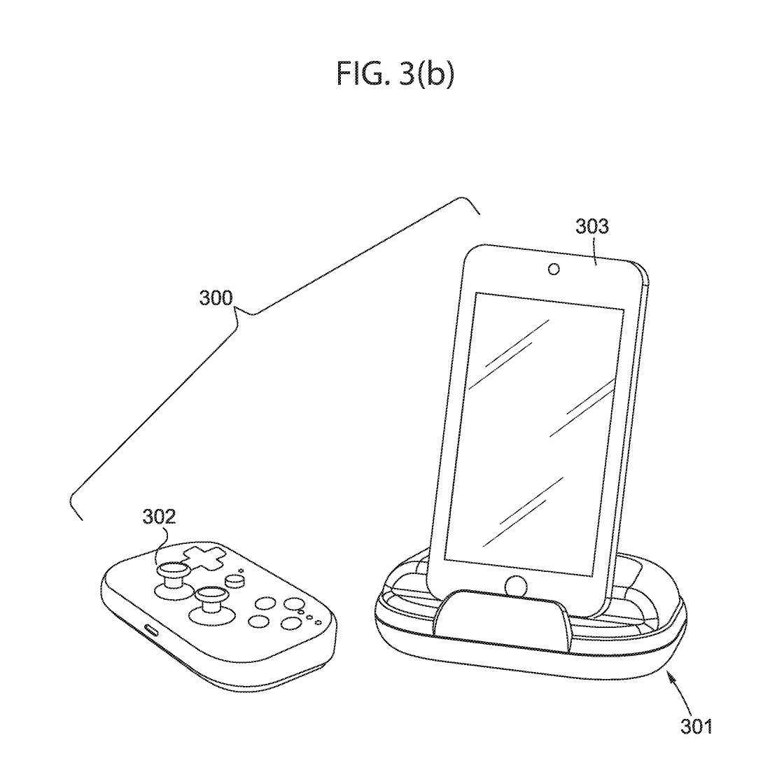

Turning now to the next set of figures: FIG. 3(a) illustrates a perspective view of an exemplary system or kit in accordance with one embodiment of the present invention, and more specifically, a perspective view of a gaming controller being used to play a game on a display device supported or coupled to an exemplary protective case, the display device in a horizontal orientation; and FIG. 3(b) illustrates the kit shown in FIG. 3(a), the display device in an alternative orientation (for example a vertically oriented). As shown in the figures, system 300 may comprise of a gaming controller and protective case kit, including a case 301, a controller 302, and a mobile device or display device 303. As shown, the gaming controller 302 is ready for use outside of case 301. As can be appreciated from these figures, case 301 can accommodate a display device 303 such as a smartphone that may be used to execute or run a video game compatible with controller 302.

Finally turning to the remaining figures, FIG. 4(a) illustrates a perspective view of an exemplary system in accordance with another embodiment of the present invention, the case in an open configuration for maximizing support of a larger display device; and FIG. 4(b) illustrates another view of the system shown in FIG. 4(a). More specifically, system 400 may comprise of a kit including protective case 401, a gaming controller 402 and a display device such as a tablet 403. In FIG. 4(a), protective case 401 is shown in an opened configuration wherein a first casing 401a of case 401 lays flat with its internal cavity facing a work surface. Simultaneously, a second casing 401b of case 401 lays flat with its internal cavity facing the work surface.

As may be noted from the figures, the display device comprises a tablet 403 that may be used for gaming and is compatible for use with gaming controller 410. As mentioned above, with larger tablets, the open configuration may be desirable as longer displays typically are better supported with a longer supporting base. When opened as shown, casings 401a and 401b effectively increase a length of a supportive base used to support a weight of tablet 403. As mentioned above, FIG. 4(b) illustrates another view of system 400 shown in FIG. 4(a).

A gaming controller protective case and stand combination has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A gaming controller case, comprising:
a first casing including a cavity adapted to receive a portion of a gaming controller that is separate and distinct from a gaming display; and
a second casing removably coupled to the first casing and having an outer surface comprising an elongated channel defined between a ridge situated along a length of the outer surface and a lip protruding above a channel surface within the elongated channel between a retaining wall of the lip and a retaining wall of the ridge, the elongated channel adapted to receive a portion of the gaming display.

2. The gaming controller case of claim 1, further comprising a hinged portion at a posterior section of the gaming controller case swivably coupling the first casing to the second casing.

3. The gaming controller case of claim 1, wherein the lip is an anterior lip and the elongated channel is situated at an anterior portion of the outer surface of the second casing.

4. The gaming controller case of claim 1, wherein the channel surface is substantially perpendicular to the retaining wall of the lip.

5. The gaming controller case of claim 1, wherein the channel surface forms an oblique angle with the retaining wall of the ridge.

6. The gaming controller case of claim 1, wherein the elongated channel is situated at a posterior portion of the outer surface of the second casing.

7. The gaming controller case of claim 1, wherein the elongated channel is situated at a middle portion of the outer surface of the second casing.

8. The gaming controller case of claim 1, wherein the first casing is a base casing and the second casing is a top casing.

9. A gaming kit, comprising:
a gaming controller that is separate and distinct from a gaming display, the gaming controller including a directional pad and a user interface including one or more action buttons; and
a protective case, comprising:
a first casing including a cavity adapted to receive a portion of a gaming controller that is separate and distinct from a gaming display; and
a second casing swivably coupled to the first casing and having an outer surface comprising an elongated channel defined between a ridge situated along a length of the outer surface and a lip protruding above a channel surface within the elongated channel between a retaining wall of the lip and a retaining wall of the ridge, the elongated channel adapted to receive a portion of the gaming display.

10. The gaming kit of claim 9, wherein the lip is an anterior lip and the elongated channel is situated at an anterior portion of the outer surface of the second casing.

11. The gaming kit of claim 9, wherein the channel surface is substantially perpendicular to the retaining wall of the lip.

12. The gaming kit of claim 9, wherein the channel surface forms an oblique angle with the retaining wall of the ridge.

13. The gaming kit of claim 9, wherein the elongated channel is situated at a posterior portion of the outer surface of the second casing.

14. The gaming kit of claim 9, wherein the elongated channel is situated at a middle portion of the outer surface of the second casing.

15. A gaming controller case, comprising:
a first casing including a cavity adapted to receive a portion of a gaming controller that is separate and distinct from a gaming display; and
a second casing swivably coupled to the first casing and having an outer surface comprising a channel defined between a first retention member and a second retention member situated along a length of the outer surface, the channel adapted to receive a portion of the gaming display.

16. The gaming controller case of claim 15, wherein the channel is an elongated channel situated at an anterior portion of the outer surface of the second casing.

17. The gaming controller case of claim 16, wherein the elongated channel includes a channel surface that is substantially perpendicular to the first retention member.

18. The gaming controller case of claim 17, wherein the channel surface forms an oblique angle with the second retention member.

19. The gaming controller case of claim 18, wherein the first retention member comprises of an anterior lip extending upwards from a center and anterior portion of the second casing.

20. The gaming controller case of claim 19, wherein the second retention member comprises of a slanted retention wall rising from the channel surface to a ridge of the outer surface of the second casing.
